(19) United States
(12) Patent Application Publication
(10) Pub. No.: US 2014/0349083 A1
(43) Pub. Date: Nov. 27, 2014

(54) CODE PLATE OF OPTICAL ENCODER

(71) Applicant: SEIKOH GIKEN CO., LTD., MATSUDO-SHI (JP)

(72) Inventors: Norihiro KAKINUMA, Matsudo-shi (JP); Masahide HIOKI, Matsudo-shi (JP); Takashi YASUDA, Matsudo-shi (JP)

(73) Assignee: SEIKOH GIKEN CO., LTD., MATSUDO-SHI (JP)

(21) Appl. No.: 14/074,714

(22) Filed: Nov. 8, 2013

(30) Foreign Application Priority Data
May 23, 2013 (JP) 2013-108899

(51) Int. Cl. G01D 5/347

(52) U.S. Cl. CPC G01D 5/34707
USPC 428/182

(57) ABSTRACT

The present invention discloses code plate of an optical encoder having a planar portion that is located on a surface to which a light flux for detection is applied; and a non-planar portion that is arranged alternatively with the planar portion on the surface and is comprised of multiple convex structures and concave structures arranged continuously intersecting to a parallel direction of arranging the planar portion and the non-planar portion. The longitudinal direction in the planar portion and the non-planar portion is consistent with the radial direction of the code plate, and a direction (Parallel direction) in which the planar portion and the non-planar portion are arranged alternately is consistent with the circumferential direction of the code plate. The non-planar portion which forms the concave and convex structure is formed by arranging multiple V-shaped structures in the longitudinal direction of the non-planar portion. Since the multiple V-shaped structures are arranged in the direction in which the non-planar portion is extending, the width of the V-shaped structure is not restricted by the width of the non-planar portion in the parallel direction.

### CROSS-REFERENCES TO RELATED APPLICATIONS

The present application is related to the Japanese Patent Application No. 2013-108899, filed May 23, 2013 and Japanese Patent Application No. 2013-161049, filed Aug. 2, 2013, the entire disclosure of which is expressly incorporated by reference herein.

### BACKGROUND OF THE INVENTION

1. Field of the Invention

The present invention relates to a code plate of an optical encoder.

2. Description of the Related Art

As a code plate of an optical encoder, a code plate disclosed in the Japanese Unexamined Patent Application Publication No. 1999-287671 is known. The code plate of the optical encoder disclosed in this Patent Application Publication includes a reflection portion formed to have a planar surface and a non-reflection portion formed to have a non-planar surface provided alternately in a ring shape. Further, in the non-reflection portion, a V-shaped groove which includes saw-tooth shaped structure or successive mountains and valleys in the cross section is formed.

Now, when it is determined that a direction in which the reflection portion (planar portion) and the non-reflection portion (non-planar portion) are arranged alternatively is referred to as parallel direction, a direction in which multiple V-shaped grooves formed in the non-reflection portion are arranged is the same direction as the parallel direction, further, each V-shaped groove is formed so as to extend toward a radial direction, that is a direction perpendicular to the parallel direction.

Since the V-shaped structures in the non-reflection portion are formed continuously, it may be possible to say that multiple mountains of inverted V-shaped structure are formed. Anyway, since the inclined plane is used to determine the traveling direction of the light flux equally in the both cases, the V-shaped structure and the mountain of the inverted V-shaped structure are referred to simply as V-shaped structure in the following description. Further, it is assumed that a width of one V-shaped mountain or one inverted V-shaped mountain formed by the two inclined surfaces which are continuing mutually is referred to as width.

In order to perform a high-precision encoding, it is expected that the formation period of the reflection portion and the non-reflection portion is made sufficiently fine. When the V-shaped structure is formed, ultimately, it may be conducted that one V-shaped structure is formed in one non-reflection portion and a portion between the V-shaped structures is set to a planar portion. Since the reflection portion and the non-reflection portion are formed alternately at a fine pitch, a high-precision encoding performance can be expected.

Now, a transmission optical rotary encoder is explained. In the transmission optical rotary encoder, when a light flux for detection is irradiated at a predetermined angle, the light flux is transmitted in the planar portion, however, it is reflected totally by the slope of the V-shaped structure in the non-planar portion, accordingly it is non-transparent. In the relation with the light-receiving sensor, in the reflection optical rotary encoder, the light flux is reflected at the planar portion and received, on the other hand, in the transmission optical rotary encoder, the light flux is transmitted at the planar portion and received, further, in the reflection optical rotary encoder, since the light flux is not reflected at the non-planar portion to a predetermined direction, the light flux is not received, on the other hand, in the transmission optical rotary encoder, since the light flux is reflected at the non-planar portion and is not transmitted, the light flux is not received.

When the code plate is formed by the injection molding method, a round R is formed at the top portion of the V-shaped structure that is the convex side of the code plate. Accordingly, in the transmission optical rotary encoder, the light flux for detection is reflected at the non-planar portion, however, cannot be not reflected at the top portion, but is transmitted. Since the light is transmitted, it becomes a cause to reduce the reflectance at the non-planar surface. This reflectance is deteriorated in accordance with the ratio of the width of the top portion for the width of a V-shaped structure. Further, the width of the top portion is mainly determined by the resin mold forming condition.

As described above, thus, in order to achieve a high-precision encoding, a single V-shaped structure may be formed in one non-planar portion, in this case, it is necessary to increase the width of the V-shaped structure to reduce the ratio of the width of the top portion occupying the width of the V-shaped structure, however, since the width of the non-planar portion is determined by the fineness to be required, there is a limit in the reduction of the deterioration of the reflectance.

### BRIEF SUMMARY OF THE INVENTION

This patent specification describes a novel code plate of an optical encoder which includes a planar portion that is located on a surface to which a light flux for detection is applied and a non-planar portion that is arranged alternatively with the planar portion on the surface and is comprised of multiple convex structures and concave structures arranged continuously intersecting to a parallel direction of arranging the planar portion and the non-planar portion. The convex structure and the concave structure have a V-shaped structure formed by two planer slopes intersecting each other at a top portion thereof, and when a width of the non-planar portion in the parallel direction is defined as WR, a projected length of the top portion for the surface plane of the code plate is defined as WC, and projected lengths of the two slopes SL1 and SL2 for the surface plane of the code plate are defined as WF1 and WF2, respectively, WC is equal to or more than 2.83 μm, and the following equations (1) and (2) are satisfied:

WF1+WF2+WC>WR (1)

WC/(WF1+WF2+WC)≦0.09 (2)

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a plan view of a code plate of an optical rotary encoder;

FIG. 2 is a side view of the code plate of the optical rotary encoder;

FIG. 3 is an enlarged perspective view of a non-planar portion;

FIG. 4 is an enlarged section view of the non-planar portion;

FIG. 5 is a section view showing an example of a V-shaped structure;

FIG. 6 is a section view showing a modification example of the V-shaped structure;

FIG. 7 is a plan view showing an example of an orientation of the V-shaped structure;

FIG. 8 is a plan view showing a modification example of the orientation of the V-shaped structure;

FIG. 9 is a plan view of a code plate of an optical linear encoder;

FIG. 10 is an enlarged perspective view of a planar portion and a non-planar portion of the conventional code plate; and

FIG. 11 is an enlarged section view of the planar portion and the non-planar portion.

### DETAILED DESCRIPTION OF THE INVENTION

The embodiment according to the present invention is described below referring to the drawings.

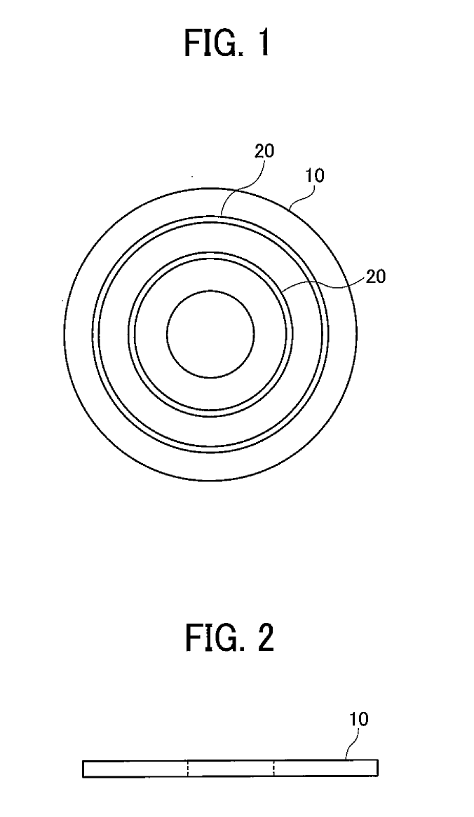

FIG. 1 is a plan view of a code plate of a transmission optical rotary encoder according to the present invention, FIG. 2 is a side view of the code plate.

A code plate 10 of a transmission optical rotary encoder is formed in a disk shape, on one surface thereof, a pattern structure portion 20 having two ring-shaped concentric circles is formed. In the present embodiment, assuming that the code plate is used in the transmission optical rotary encoder, it is formed to be a disk shape using a transparent resin material. Further, as described later, it is also possible to apply the code plate to a reflection encoder or a linear encoder.

In each pattern structure portion 20, a flat planar portion FL 21 and a non-planar portion DT 22 in which irregularities are formed on the surface thereof to have a non-planar shape are formed so as to have a rectangular shape having a longitudinal direction in the radial direction, respectively. Since the optical rotary encoder of the present embodiment is a transmission type, and in the planar portion 21 which has a flat surface, the code plate 10 is formed of a transparent material so that the light flux for detection is transmitted. On the other hand, in the non-planar portion 22 in which irregularities are formed on the surface to have a non-planar shape, the light flux for detection is totally reflected substantially when the light flux is irradiated at a predetermined angle.

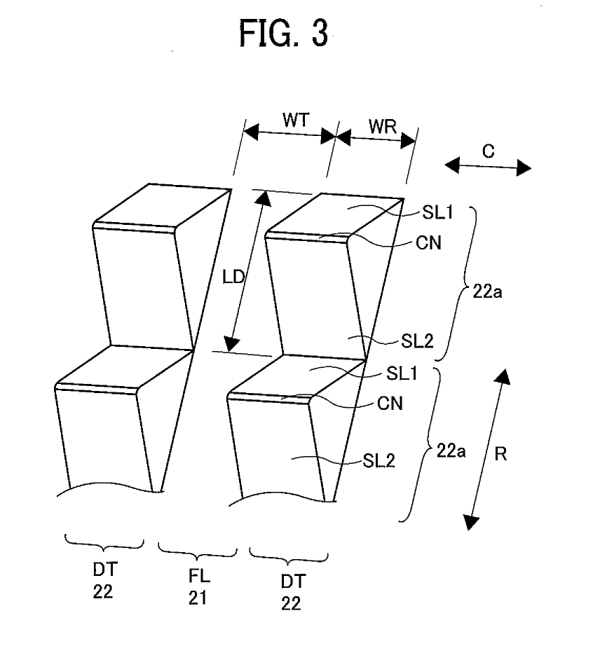

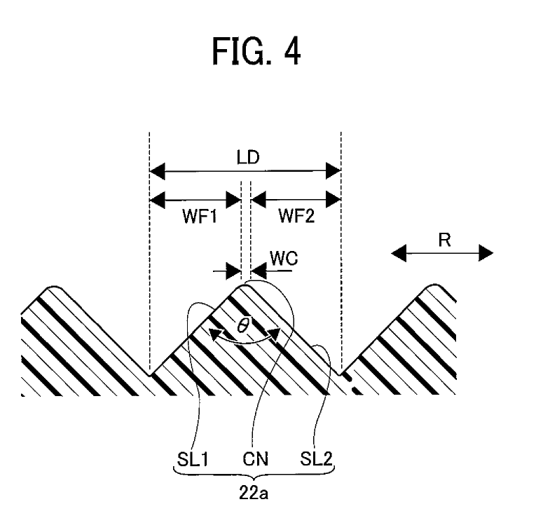

FIG. 3 is an enlarged perspective view of the non-planar portion, and FIG. 4 is an enlarged section view of the non-planar portion.

The non-planar portion DT 22 is formed in an elongated rectangular shape so as to protrude from the planar portion FL 21 which is a flat plate surface of substantially planar. Further, the planar portion 21 is continuous with the part other than the pattern structure 20. In this sense, the side in the radial direction has a boundary which is in contact with the non-planar portion 22, the side in the circumferential direction does not have a clear boundary, and it may not have a rectangle shape. However, simply observing the pattern structure portion 20 which is ring-shaped, since the inner circle which is ring-shaped and the outer circle which is ring-shaped form substantially parallel two sides, it may be possible to say that it is a rectangle shape.

However, it is not necessary that both the planar portion FL 21 and the non-planar portion DT 22 have rectangular shapes, but it may be sufficient to have a condition in which they alternately across the region through which the light flux for detection is irradiated.

Further, in this embodiment, the non-planar portion 22 is protruding from the planar portion 21, and the bottom of the valley which is the concave portion is positioned at the same height as the planar portion 21. However, conversely, it is possible to form so that the non-planar portion 22 is disposed lower than the planar portion 21 so that the top portion is positioned at the height of the planar portion 21. Thus, any modification is possible in consideration of the condition of the injection molding process.

It is clear that the two concentric ring-shaped pattern structures 20 have different circumferential lengths to each other basically. However, in the multiple ring-shaped pattern structures 20 formed concentrically, it is formed so as to match the width and the spacing of the planar portion 21 and the non-planar portion 22 roughly between them, as a result, the pattern structure portion 20 of the inner circle has different numbers of the planar portion 21 and the non-planar portion 22 from those of the pattern structure portion 20 of the outer circle. Accordingly, the formation positions (angular position) of the planar portion 21 and the non-planar portion 22 are different between the inner circle and the outer circle, however, as described later, in the present invention, it is possible to easily change the formation positions of the non-planar portion 22 in the inner circle and the outer circle.

When it is set to match the width and the spacing of the planar portion 21 and the non-planar portion 22 roughly in the inner circle and the outer circle, it is possible to use the common electrical circuit, etc. which include the light-emitting element for detection and the sensor for receiving the light flux. When it is needed to form the planar portion 21 and the non-planar portion 22 in the inner circle at the same angular position as that in the outer circle, the widths and the spaces of the planar portion 21 and the non-planar portion 22 in the inner circle differ from those in the outer circle.

Further, in the present invention, the pattern structure portions 20 are formed in a ring shape at a plurality of the positions concentrically, however, it is not necessarily to be a plurality, but it may be a single. Further, it is not limited to be two, but it may be three or more.

In practice, the light flux for detection is irradiated at a predetermined position, and when the code plate 10 is rotated about the axis, the planar portion 21 and the non-planar portion 22 which are disposed in a ring shape enter the light flux path and go out from the light flux path alternately. In this sense, it can be said that the light flux for detection is not moved, but the light flux is scanned on the planar portion 21 and the non-planar portion 22, relatively.

In FIG. 3, the longitudinal direction in the planar portion 21 and the non-planar portion 22 which are formed in an elongated rectangular shape is consistent with the radial direction of the code plate 10. A direction (Parallel direction) in which the planar portion 21 and the non-planar portion 22 are arranged alternately is consistent with the circumferential direction C of the code plate 10. Further, the non-planar portion 22 corresponds to the convex or the concave structure in the present invention.

As shown in the section view of FIG. 4, the non-planar portion 22 is formed by arranging multiple V-shaped structures 22a which becomes the convex structure in the longitudinal direction of the non-planar portion 22. The longitudinal direction is the radial direction, and the radial direction is perpendicular to the circumferential direction C (Parallel direction), accordingly, multiple convex structures are arranged in a direction crossing the parallel direction. Further, in the present embodiment, a case in which multiple convex structures are arranged orthogonally to the parallel direction is shown as an example. In each V-shaped structure 22a, two slopes of planar surface SL1 and SL2 are intersecting at the top portion CN to form a V-shaped structure in the cross-section. In the drawing, an angle at which the slopes SL1 and SL2 are intersecting at a top portion CN is set to approximately 90°. The slope is provided for causing the total reflection, accordingly, it is possible to set an optimum angle in accordance with the light flux for detection and the irradiation angle. For an example, it may be sufficient that the slopes intersect at an angle of equal to or less than approximately 110°.

Each V-shaped structure 22a has a width of the non-planar portion 22 in the parallel direction and a width LD in the radial direction R. Further, the projected length of the slopes SL1 and SL2 for the surface plane of the code plate 10 are WF1 and WF2, respectively, the projected length of the top portion CN is WC. The top portion CN have a predetermined length due to a dullness caused by the molten resin because the molten resin is impenetrable to narrow gap of the mold. It is unavoidable in the resin molded component, however, it is possible to reduce the degree of dullness with the molding method of the code plate 10. For example, if it is cut in each code plate individually, it is possible to make the projected length WC of the top portion CN to below 2.0 μm. On the other hand, it consumes a relatively long time to form it, and it is difficult to form a mirror surface on the slope for the total reflection. Further, according to the imprinting method, the accuracy of the molded product for the mold may be improved, and it is possible to form a projected length WC of the top portion CN of below 2.0 μm similarly to the individual cutting method, however, it takes a relatively long time to form the one code plate. On the other hand, in terms of cost performance, the general injection molding has an advantage as the forming method for this kind of the code plate, however, the projected length WC of the top portion CN may be long compared to those by the two molding methods described above.

On the other hand, it is required that the non-planar portion 22 has a predetermined reflectance to use it as a product. There is almost no transmitting light at the slopes SL1 and SL2 because of the total reflection, however, it is not possible to achieve the total reflection at the top portion CN, and a part of the light flux may transmit. Therefore, it becomes a factor to reduce the reflectance in the non-planar portion 22.

Theoretically, in the two planar slopes SL1 and SL2 which form the V-shaped structure and the top portion CN, it is possible to calculate the degradation of the reflectance in accordance with the projected areas for the surface plane of each code plate 10. More specifically, since the light is totally reflected by the projected areas of the slopes SL1 and SL2 and is transmitted by the projected area of the top portion CN, it is possible to calculate the degradation of the reflectance by the ratio of the projected areas. Hereinafter, this degradation is represented by degradation rate DR. In order to use the device as a product, it is desired that the deterioration rate DR is equal to or less than 9%.

Now, it is defined that the lengths occupied by the slopes SL1 and SL2 for the surface of the code plate 10 are WF1 and WF2, respectively, and the length occupied by the top portion CN is WC. Since the width of the non-planer portion 22 is constant, the ratio of the projected areas of the slopes SL1 and SL2 and the top portion CN is WF1:WF2:WC. Therefore, the degradation rate DR is expressed as

DR=WC/(WF1+WC+WF2)

Accordingly, when it is assumed the length WC occupied by the top portion CN is a fixed value, the lengths WF1 and WF2 occupied by the slopes SL1 and SL2 may be increased to reduce the degradation rate DR.

In the present embodiment, the diameter of the code plate 10 is approximately 32 mm, the lengths of the planar portion 21 and the non-planar portion 22 in the parallel direction that is the circumferential direction are 30 μm, respectively, and the length in the longitudinal direction that is the radial direction is 260 μm. Since they have the same length in the parallel direction and are disposed alternately, it may be referred to as pitch in the following description. In this embodiment, the width WT of the planar portion 21 is determined to match with the width WR of the non-planar portion 22, however, it is not necessary to match.

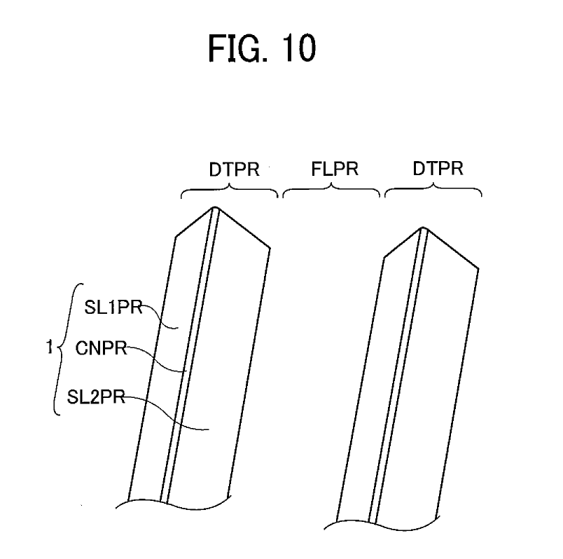

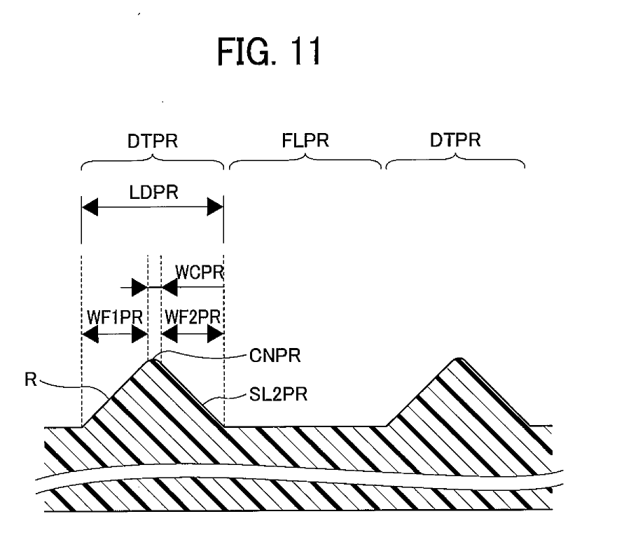

FIG. 10 is an enlarged perspective view illustrating a planar portion (FLPR) and a non-planar portion (DTPR) when the V-shaped structure is extending in the radial direction in the conventional device. FIG. 11 is an enlarged section view illustrating the planar portion and the non-planar portion.

In the code plate of this optical encoder, one V-shaped structure 1 is formed in one non-reflection portion DTPR to perform a high-precision encoding. More specifically, the non-planar portion DTPR of elongated rectangular shape is one V-shaped structure 1 of elongated shape, and the direction in which the rectangular shape is extending matches with the direction in which the V-shaped structure 1 is extending. In this case, it is obvious that the width LDPR of the V-shaped structure matches the width of the non-planar portion DTPR. Alternatively, it is also possible to form multiple V-shaped structures while maintaining the extending direction of the V-shaped structure, however, if the multiple V-shaped structures are formed, the width LDPR of the V-shaped structure becomes small compared to the width of the non-planar portion DTPR.

Now, as shown in FIGS. 10 and 11, when a single V-shaped structure 1 is formed in one non-reflection portion to maximize the width LDPR, there is a top portion CNPR also in addition to the slopes SL1PR and SL2PR in the V-shaped structure 1. When the lengths of the slopes and the top portion for the surface of the code plate are WF1PR, WF2PR and WCPR, respectively, the degradation rate DRPR described above is expressed as

DRPR=WCPR/(WF1PR+WCPR+WF2PR).

When the code plate is formed by the injection molding method, the width of the non-planar portion is 30.0 μm, the length of the width LDPR of the V-shaped structure 1 is 30.0 μm, and the length of the top portion CNPR for the surface of the code plate is equal to or more than 2.83 μm. Accordingly, the degradation rate DRPR is expressed as

$$DRPR = WCPR / ( WF 1 PR + WCPR + WF 2 PR ) \geq 2.83 \text{/} 30.0 \geq 0.0943$$

In other words, the degradation rate DRPR is equal to or more than 9.43%, and further improvement cannot be expected. Because, as far as the direction in which the V-shaped structure 1 is extending is consistent with the extending direction of the non-planar portion DTPR, it is not possible to make the width LDPR of the V-shaped structure larger than the width LDPR of the non-planar portion DTPR.

On the other hand, in the present invention, since the multiple V-shaped structures 22a are arranged in the direction in which the non-planar portion 22 is extending, the width LD of the V-shaped structure 22a is not limited by the width of the non-planar portion 22 in the parallel direction. As an example, when the width LD is 60 μm and the length WC of the top portion for the surface of the code plate is 2.83 μm, the degradation rate DR is expressed as

$$\begin{matrix}DR = WC / ( WF 1 + WC + WF 2 ) \\ = 2.83 \text{/} 60.0 \\ = 0.0472\end{matrix}$$

That is, the degradation rate DR is 4.72%, thus, it is found that the degradation rate can be improved greatly compared to that in the conventional device.

If it is desired that the degradation rate DR is set to 9%, the width LD of the V-shaped structure 22a may be determined to 31.4 μm. Even in the improvement upto 9%, there is a large difference in the yield depending on the required accuracy of the transmittance for the product. Further, from the sense of improvement of the performance, of course, it is also possible to set the width LD of the V-shaped structure 22a to equal to or more than 40.4 μm so that the degradation rate becomes equal to or lower than 7%.

Thus, it became possible to improve the deterioration rate DR compared to the conventional device by setting the width LD of each V-shaped structure 22a larger than the width of the non-planar portion 22 in the parallel direction.

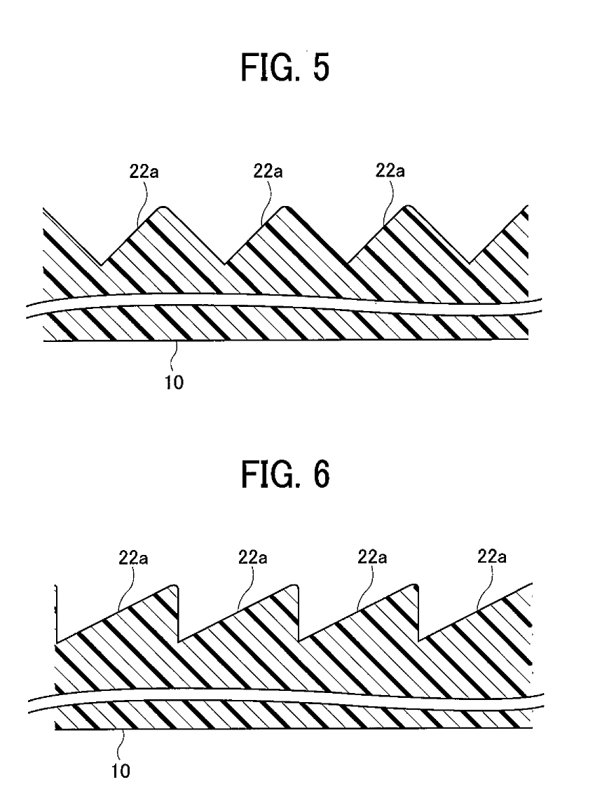

FIG. 5 is a section view of an example of a V-shaped structure, and FIG. 6 is a section view of a modification example of a V-shaped structure.

In this embodiment, since a V-shaped structure 22a which becomes a mountain-shaped structure is adopted to form multiple convex or concave structures, as shown in FIG. 5, each V-shaped structure 22a forms an isosceles right triangle in which two slopes SL1 and SL2 are provided substantially symmetrical with respect to the surface of the code plate 10. However, the V-shaped structure 22a is not limited to such an isosceles right triangle, but may be a saw-tooth shaped right-angled triangle as shown in FIG. 6. Further, it is also possible to change the structure appropriately so as to achieve the total reflection when the angle at which two slopes SL1 and SL2 are intersecting is in the range of equal to or less than approximately 110°.

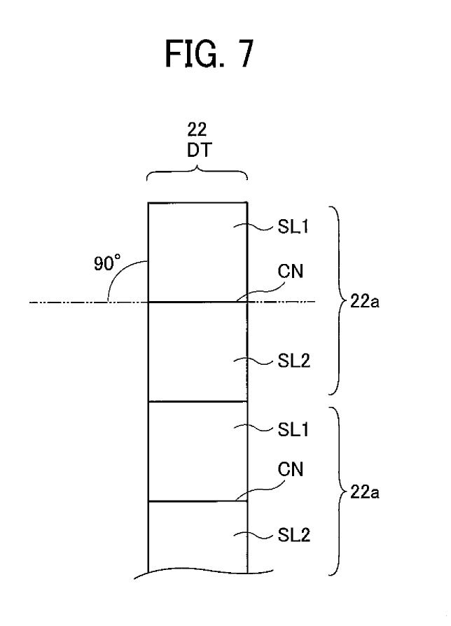

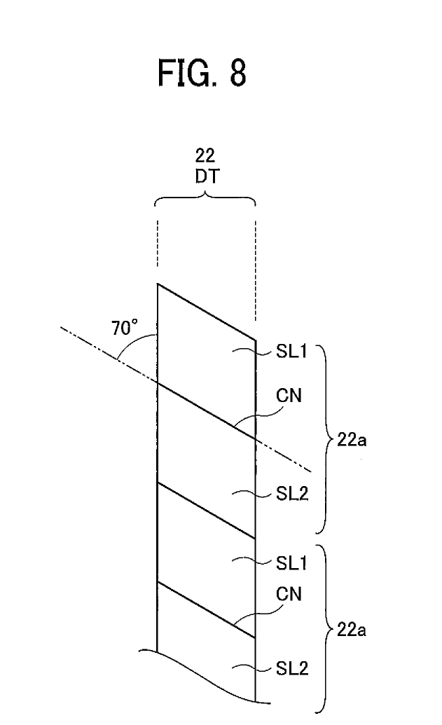

Next, FIG. 7 is a plan view of an example of an orientation of the V-shaped structure, and FIG. 8 is a plan view of a modification example of the orientation of the V-shaped structure.

In this embodiment, the direction in which multiple V-shaped structures 22a are arranged is substantially perpendicular to the parallel direction. In other words, the direction in which the V-shaped structure 22a are arranged is orthogonal to the direction in which the top portion CN is extending. Now, it is called inclination of the V-shaped structure 22a, and it is 90° when it is orthogonal.

In the devices shown in FIGS. 3 through 7, the inclination angle is 90°, however, it is not necessary that the inclination angle is 90°. For example, even when the angle is 70° as shown in FIG. 8, it is possible to make the width of the convex or concave structure larger than the width of the non-planar portion by arranging multiple convex or concave structures in a direction crossing the parallel direction. However, from the consideration of the work to manufacture the molding tool, it is preferable to form it substantially along the circumferential direction.

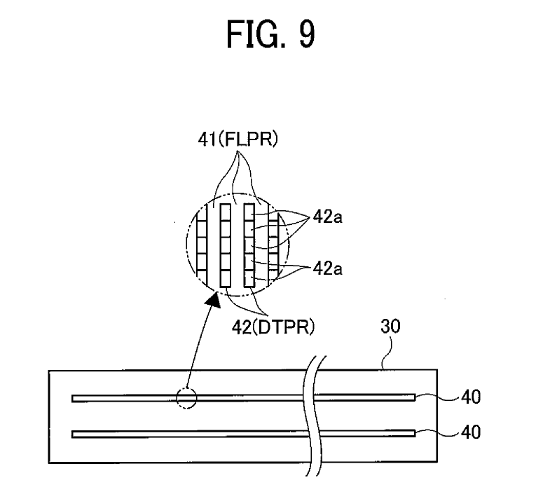

FIG. 9 is a plan view of a code plate of an optical linear encoder.

In the embodiment described above, the present invention is applied to the code plate of the transmission optical rotary encoder. More specifically, the pattern structure portion 20 in which the planar portion 21 and the non-planar portion 22 are formed alternately is formed in a ring shape, further, in the present embodiment, the pattern structure portion 20 is formed in a ring shape at multiple positions concentrically.

However, the present invention is applicable similarly in the code plate 30 of the linear encoder shown in FIG. 9, a pattern structure portion 40 in which the planar portion 41 and the non-planar portion 42 are formed alternately may be formed approximately in a linear arrangement. Obviously, in the non-planar portion 42, setting the parallel direction in which the planar portion 41 and the non-planar portion 42 are arranged alternately as the reference direction, multiple V-shape structures 42a are formed so as to be arranged in the direction crossing the parallel direction so that the width of each V-shaped structure 42a is made large compared to the width of the non-planar portion 42 in the parallel direction.

In the embodiment described above, the transmission optical rotary encoder is described, however, it is also true in the reflective optical encoder similarly. In the reflective optical encoder, the reflective material is coated on the surface of the code plate so that the light is totally reflected in the planar portion to a predetermined direction in which the light receiving elements are provided to receive the light. In this case, the light receiving element detects the bright section. By contrast, in the non-planar portion, the light is totally reflected in a direction in which the light receiving elements are not provided so that the light receiving element can detect the dark section.

However, some of the reflected light may be received by the light receiving element because of the dullness formed at the top portion in the non-planar portion. Further, in this case, the top portion formed by the injection molding may not be a size less than around a predetermined value, as a result, there is some limitation in the degradation rate of the non-reflectance in the region in which it must be non-reflective due to the limitation of the width of the V-shaped structure.

However, by applying the present invention, the width of the V-shaped structure is not limited by the width of the non-planar portion in the arrangement direction thereof so that it is possible to achieve further reduction of the degradation rate of the non-reflectance.

Further, the V-shaped structure is employed for the convex or concave structure, however, as far as it is possible to eliminate the deterioration of the permeability and reflectivity caused by the dullness at the top portion, it is not limited to the V-shaped structure, but a concave or convex structure of other shape can be applied. Numerous additional modifications and variations are possible in light of the above teachings. It is therefore to be understood that within the scope of the appended claims, the disclosure of this patent specification may be practiced otherwise than as specifically described herein.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

What is claimed is:

1. A code plate of an optical encoder, comprising:
a planar portion that is located on a surface to which a light flux for detection is applied; and
a non-planar portion that is arranged alternatively with the planar portion on the surface and is comprised of multiple convex structures and concave structures arranged continuously intersecting to a parallel direction of arranging the planar portion and the non-planar portion,
wherein the convex structure and the concave structure have a V-shaped structure in the cross-section formed by two planer slopes intersecting each other at a top portion thereof, and when a width of the non-planar portion in the parallel direction is defined as WR, a projected length of the top portion for the surface plane of the code plate is defined as WC, and projected lengths of the two slopes SL1 and SL2 for the surface plane of the code plate are defined as WF1 and WF2, respectively, WC is equal to or more than 2.83 μm, and the following equations (1) and (2) are satisfied:
WF1+WF2+WC>WR (1)
WC/(WF1+WF2+WC)≦0.09 (2)

2. The code plate of an optical encoder according to claim 1,
wherein the following equation (3) is satisfied,
WC/(WF1+WF2+WC)≦0.07 (3)

3. The code plate of an optical encoder according to claim 1,
wherein the two slopes which form the V-shaped structure intersect at an angle of equal to or less than 110°.

4. The code plate of an optical encoder according to any of claim 1,
wherein the multiple convex and concave structures are arranged substantially perpendicular to the parallel direction.

5. The code plate of an optical encoder according to any of claim 1,
wherein pattern structure portions comprising of the planar portion and the non-planar portion are formed alternately are formed in a plurality of positions in a ring shape concentrically.

6. The code plate of an optical encoder according to any of claim 1,
wherein a pattern structure portion comprising of the planar portion and the non-planar portion formed alternately is formed approximately in a linear arrangement.

7. The code plate of an optical encoder according to any of claim 1,
wherein the code plate is made of resin.

8. The code plate of an optical encoder according to claim 7,
wherein the code plate is manufactured by using an injection molding method.
